(19) United States
(12) Patent Application Publication
(10) Pub. No.: US 2019/0341200 A1
(43) Pub. Date: Nov. 7, 2019

(54) YOLK-SHELL STRUCTURES CONTAINING POLYSULFIDE TRAPPING AGENTS, METHODS OF PREPARATION, AND USES THEREOF

(71) Applicant: SABIC Global Technologies B.V., Bergen op Zoom (NL)

(72) Inventors: Yunyang LIU, Thuwal (SA); Ihab N. ODEH, Sugar Land, TX (US)

(21) Appl. No.: 16/475,185

(22) PCT Filed: Jan. 4, 2018
(86) PCT No.: PCT/US2018/012358

§ 371 Date: Jul. 1, 2019

Related U.S. Application Data
(60) Provisional application No. 62/443,167, filed on Jan. 6, 2017.

(51) Int. Cl. H01G 11/24; H01M 4/86; H01M 4/62; H01M 4/48; H01M 4/38; H01G 11/32; H01G 11/26; H01G 11/50; H01G 11/46; H01G 11/48; H01M 10/052

(52) U.S. Cl. CPC H01G 11/24; H01M 4/8615; H01M 4/625; H01M 4/48; H01M 4/382; H01M 10/052; H01G 11/26; H01G 11/50; H01G 11/46; H01G 11/48; H01G 11/32

(57) ABSTRACT

Porous materials having yolk-shell structures are described. A porous material can include an elemental sulfur nanostructure, a carbon-containing porous shell with an exterior surface and an interior surface that defines and encloses a hollow space within the interior of the shell, and a polysulfide trapping agent. The elemental sulfur nanostructure is comprised in the hollow space of the carbon-containing porous shell. Methods of making and use are also described.

### CROSS REFERENCE TO RELATED APPLICATIONS

This application claims the benefit of priority of U.S. Provisional Patent Application No. 62/443,167 filed Jul. 6, 2017, which is hereby incorporated by reference in its entirety.

### BACKGROUND OF THE INVENTION

### A. Field of the Invention

The invention generally concerns a porous material having a yolk-shell structure that includes a polysulfide trapping agent. The porous material can include an elemental sulfur nanostructure comprised in hollow space of the interior of the porous material.

### B. Description of Related Art

The increasing energy demand and environmental concerns have caused a need for environmentally friendly energy storage systems that are safe and low cost and have high energy densities. To meet this need, lithium-sulfur (Li—S) batteries have been developed as they (1) have a high theoretical capacity of 1672 mAh g⁻¹, which is over 5 times that of currently used transition metal oxide cathode materials, (2) are relatively inexpensive to manufacture due to abundant resources of sulfur, and (3) have nonpoisonous and environmentally benign characteristics. However, the practical application of Li—S battery cells is still limited by the following drawbacks (1) poor electrical conductivity of sulfur (5×10⁻³⁰ S cm⁻¹) limits the utilization efficiency of active material and rate capability, (2) high solubility of polysulfide intermediates in the electrolyte results in a shuttling effect in the charge-discharge process, and (3) large volumetric expansion (about 80%) during charge and discharge, which results in rapid capacity decay and low Coulombic efficiency.

The high capacity and cycling ability of sulfur can arise from the electrochemical cleavage and re-formation of sulfur-sulfur bonds in the cathode, which, without wishing to be bound by theory, is believed to proceed in two steps. First, the reduction of sulfur to lithium higher polysulfides (Li₂Sₙ where 4≤n≤8) is followed by further reduction to lithium lower polysulfides (Li₂Sₙ where 1≤n≤3). The higher polysulfides can be dissolved into an organic liquid electrolyte, enabling them to penetrate through a polymer separator between the anode and cathode, and then react with the lithium metal anode, leading to the loss of sulfur active materials. Even if some of the dissolved polysulfides diffuse back to the cathode during the recharge process, the sulfur particles formed on the surface of the cathode are electrochemically inactive owing to the poor conductivity. Such a degradation path leads to poor capacity retention, especially during long cycling (e.g., more than 100 cycles).

Various attempts to improve the capacity and the conductivity of Li—S devices, while preventing polysulfide dissolution and shuttling, have been disclosed. By way of example, Seh et al. (Nat Commun 2013, 4:1331) describes the use of sulfur@TiO₂ yolk-shell nanoparticles, in a cathode for Li—S batteries to address polysulfide dissolution. In another example, U.S. Patent Application Publication No. 2015/0221935 to Zhou et al. describes a sulfur@carbon yolk-shell material for use in lithium-sulfur batteries or lithium ion batteries where the carbon shell is coated with a polymer. In yet another example, International Application Publication No. WO 2015/174931 to Ding et al., describes a porous particle that includes electrically conductive continuous shell (e.g., graphite, graphene, carbon nanotubes or amorphous carbon) that encapsulates a core capable of reversibly reducing in the presence of a cation or anion (e.g., phosphorus, arsenic, antimony, sulfur, selenium, tellurium and polonium).

Other attempts to improve the capacity and the conductivity of Li—S devices concern controlling the deposition of the discharge product Li₂S, which is an ionic and electronic insulator. By way of example, Tao et al. (Nat. Commun., 2016, 5) describes Li₂S bound to metal oxide/carbon supports where the metal oxides have been anchored on the carbon using biotemplating methods. In yet another example, U.S. Patent Application Publication No. 2015/0056507 to Dadheech et al. describes a metal oxide/carbon coating that encapsulates sulfur-based particles.

A further attempt to improve the capacity and the conductivity of Li—S devices involves using Li₂S as a starting cathode material, which can undergo volumetric contraction instead of expansion. By way of example, She et al. (Nat. Commun., 2014, 5) describes two-dimensional layered transition metal disulfides for encapsulation of lithium sulfide cathodes.

Despite all of the currently available attempts to improve the capacity and the conductivity of Li—S materials, many of these materials suffer from capacity degradation during charge-discharge cycles. Further, the continuous expansion/de-expansion cycle during lithiation and delithiation leads to formation of polysulfides and ultimately battery failure. In addition, these materials have potential for cell, battery system and pack instability due to volumetric stress and possible risk to dimensional integrity/stability of the energy storage device. Such risks can lead to unplanned thermal issues and create safety hazards.

### SUMMARY OF THE INVENTION

A solution to the problems associated with the formation of polysulfides in a Li—S material has been discovered. The solution lies in the addition of a polysulfide trapping agent to a porous material having a yolk-shell structure. The yolk can be an elemental sulfur nanostructure(s) encapsulated in a carbon-containing porous shell. The polysulfide trapping agent can be embedded in the shell, in contact with the interior surface of the carbon-containing porous shell, comprised in the hollow space, and/or in contact with the elemental sulfur nanostructure, or any combination thereof. This combination of materials results in a porous material that allows for expansion of the sulfur nanostructures and capture of any produced polysulfides, specifically, higher order lithium polysulfides (Li₂Sₙ, where 4≤n≤8), while providing increased cyclability. Furthermore, the yolk-shell materials can be formed into honeycomb structure for provide improved mechanical strength. The porous materials are suitable for use in energy devices (e.g., lithium batteries, capacitors, supercapacitors and the like, preferably a lithium-sulfur secondary battery).

In a particular aspect of the invention, a porous material having a yolk-shell structure is described. The porous material can include an elemental sulfur nanostructure, a carbon-containing porous shell with an exterior surface and an interior surface that defines and encloses a hollow space within the interior of the shell, and a polysulfide trapping agent. The elemental sulfur nanostructure can be comprised in the hollow space of the carbon-containing porous shell. The sulfur nanostructure can be derived from a metal sulfide. For example, a transition metal sulfide having a transition metal selected from zinc (Zn), copper (Cu), cobalt (Co), manganese (Mn), iron (Fe), nickel (Ni), lead (Pb), silver (Ag), cadmium (Cd), or any combination thereof, preferably Zn. The polysulfide trapping agent can be a metal oxide. Non-limiting examples of metal oxides include MgO, Al₂O₃, CeO₂, La₂O₃, SnO₂, Ti₄O₇, TiO₂, MnO₂, or CaO, or any combination thereof. In a particular aspect, Al₂O₃ and/or TiO₂ can be used as the polysulfide trapping agent. The polysulfide trapping agent can be embedded in the carbon-containing porous shell, in contact with the interior surface of the carbon-containing porous shell, comprised in the hollow space, and/or in contact with the elemental sulfur nanostructure, or any combination thereof. In a particular aspect, the polysulfide trapping agent is comprised in the hollow space and/or in contact with the elemental sulfur nanostructure. The porous carbon-containing material of the present invention can be formed into a honeycomb structure such that the material includes a plurality of hollow spaces within the interior of the shell and a plurality of the elemental sulfur nanostructures. Each of the hollow spaces can include the elemental sulfur nanostructure.

In another aspect of the invention, a method of making the porous material of the present invention is described. The method can include (a) obtaining a core-shell material that includes an elemental sulfur precursor material core, a carbon-containing shell encompassing the core, and polysulfide trapping agent and/or a polysulfide trapping agent precursor material, (b) thermally treating the core-shell material to (i) form a carbon-containing porous shell and optionally (ii) oxidize the polysulfide trapping agent precursor material to form a polysulfide trapping agent, and (c) subjecting the core-porous shell material to conditions sufficient to oxidize the elemental sulfur precursor material core to form an elemental sulfur nanostructure comprised within a hollow space of the porous shell. Embodiments to obtain the core-shell material of step (a) can include coating the elemental precursor material core with a polysulfide trapping agent and/or a polysulfide trapping agent precursor material, and forming a carbon-containing shell around the coated elemental sulfur precursor material core. A plurality of elemental sulfur precursor material cores can be coated with the polysulfide trapping agent and/or polysulfide trapping agent precursor material, where the carbon-containing shell encompasses the plurality of the coated elemental sulfur precursor material cores. Other embodiments to obtain the core-shell material of step (a) can include obtaining a dispersion comprising the polysulfide trapping agent and/or polysulfide trapping agent precursor material dispersed within elemental precursor material core, and forming a carbon-containing shell around the dispersion. Still other embodiments to obtain the core-shell material of step (a) can include obtaining a mixture comprising the polysulfide trapping agent and/or polysulfide trapping agent precursor material, the elemental precursor material core, and a carbon-containing shell forming material, and forming a carbon-containing shell around the polysulfide trapping agent precursor material and the elemental precursor material core. The carbon-containing shell encompassing the core in step (a) can include an organic polymer (e.g., polyacrylonitrile, polydopamine, polyalkylene, polystyrene, polyacrylate, poly halide, polyester, polycarbonate, polyimide, phenol formaldehyde resin, epoxy, polyalkylene glycol, polysaccharide, polyethylene, polypropylene, polymethylmethacrylate, polyvinyl chloride, polyethylene terephthalate, polyethylene glycol, polypropylene glycol, starch, glycogen, cellulose, or chitin, or any combination thereof, preferably polyacrylonitrile). In some embodiments, less than 50% of the surface of the elemental sulfur nanostructure contacts an interior surface of the porous shell.

Embodiments of the present invention include energy storage devices that include the porous material of the present invention. The energy storage device can be a secondary battery (e.g. rechargeable battery), a capacitor, or a supercapacitor having the porous material comprised in an electrode of the device. The electrode can be the anode or cathode of the device. In certain instances, it is the cathode. The rechargeable battery can be a lithium-ion or lithium-sulfur battery.

In a particular aspect of the invention, 20 embodiments are described. Embodiment 1 is a porous material having a yolk-shell structure, the porous material comprising: (a) an elemental sulfur nanostructure; (b) a carbon-containing porous shell with an exterior surface and an interior surface that defines and encloses a hollow space within the interior of the shell, wherein the elemental sulfur nanostructure is comprised in the hollow space; and (c) a polysulfide trapping agent. Embodiment 2 is the porous material of embodiment 1, wherein the polysulfide trapping agent is embedded in the carbon-containing porous shell, in contact with the interior surface of the carbon-containing porous shell, comprised in the hollow space, and/or in contact with the elemental sulfur nanostructure, or any combination thereof. Embodiment 3 is the porous material of embodiment 2, wherein the polysulfide trapping agent is comprised in the hollow space and/or in contact with the elemental sulfur nanostructure. Embodiment 4 is the porous material of any one of embodiments 1 to 3, wherein the polysulfide trapping agent is a metal oxide. Embodiment 5 is the porous material of embodiment 4, wherein metal oxide comprises MgO, Al₂O₃, CeO₂, La₂O₃, SnO₂, Ti₄O₇, TiO₂, MnO₂, or CaO, or any combination thereof. Embodiment 6 is the porous material of embodiment 5, wherein the metal oxide is Al₂O₃. Embodiment 7 is the porous material of any one of embodiments 1 to 6, wherein the elemental sulfur nanostructure is derived from a metal sulfide. Embodiment 8 is the porous material of embodiment 7, wherein the metal sulfide comprises a transition metal selected from zinc (Zn), copper (Cu), cobalt (Co), manganese (Mn), iron (Fe), nickel (Ni), lead (Pb), silver (Ag), cadmium (Cd), or any combination thereof, preferably Zn. Embodiment 9 is the porous material of any one of embodiments 1 to 8, further comprising a honeycomb structure such that the material includes a plurality of hollow spaces within the interior of the shell and a plurality of the elemental sulfur nanostructures, wherein each of the hollow spaces includes the elemental sulfur nanostructure comprised in the hollow space. Embodiment 10 is the porous material of any one of embodiments 1 to 9, wherein the material is comprised in an electrode, preferably a cathode, of an energy storage device, preferably a lithium-sulfur secondary battery.

Embodiment 11 is a method of making the porous material of any one of claims 1 to 10, the method comprising: (a) obtaining a core-shell material comprising an elemental sulfur precursor material core, a carbon-containing shell encompassing the core, and a polysulfide trapping agent and/or polysulfide trapping agent precursor material; (b) heat-treating the core-shell material to (i) form a carbon-containing porous shell and optionally (ii) oxidize the polysulfide trapping agent precursor material to form a polysulfide trapping agent; and (c) subjecting the core-porous shell material to conditions sufficient to oxidize the elemental sulfur precursor material core to form an elemental sulfur nanostructure comprised within a hollow space of the porous shell. Embodiment 12 is the method of embodiment 11, wherein the core-shell material in step (a) is obtained by: (i) coating the elemental sulfur precursor material core with a polysulfide trapping agent and/or polysulfide trapping agent precursor material; and (ii) forming a carbon-containing shell around the coated elemental sulfur precursor material core. Embodiment 13 is the method of embodiment 12, wherein a plurality of elemental sulfur precursor material cores are coated with the polysulfide trapping agent and/or polysulfide trapping agent precursor material, and wherein the carbon-containing shell encompasses the plurality of the coated elemental sulfur precursor material cores. Embodiment 14 is the method of embodiment 11, wherein the core-shell material in step (a) is obtained by: (i) obtaining a dispersion comprising the polysulfide trapping agent and/or polysulfide trapping agent precursor material dispersed with a sulfur source and a metal source; and (ii) forming a carbon-containing shell around the dispersion. Embodiment 15 is the method of embodiment 11, wherein the core-shell material in step (a) is obtained by: (i) obtaining a mixture comprising the polysulfide trapping agent and/or polysulfide trapping agent precursor material, the elemental precursor material core, and a carbon-containing shell forming material; and (ii) forming a carbon-containing shell around the polysulfide trapping agent precursor material and the elemental precursor material core. Embodiment 16 is the method of any one of embodiments 11 to 15, wherein less than 50% of the surface of the elemental sulfur nanostructure contacts an interior surface of the porous shell. Embodiment 17 is the method of any one of embodiments 11 to 16, wherein the carbon-containing shell encompassing the core in step (a) comprises an organic polymer. Embodiment 18 is the method of embodiment 17, wherein the organic polymer is polyacrylonitrile, polydopamine, polyalkylene, polystyrene, polyacrylate, poly halide, polyester, polycarbonate, polyimide, phenol formaldehyde resin, epoxy, polyalkylene glycol, polysaccharide, polyethylene, polypropylene, polymethylmethacrylate, polyvinyl chloride, polyethylene terephthalate, polyethylene glycol, polypropylene glycol, starch, glycogen, cellulose, or chitin, or any combination thereof, preferably polyacrylonitrile. Embodiment 19 is the method of any one of embodiments 11 to 18, wherein the elemental sulfur precursor material comprises a metal sulfide selected from ZnS, CuS, MnS, FeS, CoS, NiS, PbS, Ag₂S, or CdS, or any combination thereof, preferably ZnS.

Embodiment 20 is an energy storage device comprising the porous material of any one of embodiments 1 to 10, wherein the porous material is comprised in an electrode of the energy storage device.

The following includes definitions of various terms and phrases used throughout this specification.

The “yolk/shell structure” phrase means that less than 50% of the surface of the “yolk” contacts the shell. The yolk/shell structure has a volume sufficient to allow for volume expansion of the yolk without deforming the porous material. The yolk can be a nano- or microstructure. A “core/shell structure” means that at least 50% of the surface of the “core” contacts the shell.

Determination of whether a core/shell or yolk/shell is present can be made by persons of ordinary skill in the art. One example is visual inspection of a transition electron microscope (TEM) or a scanning transmission electron microscope (STEM) image of a porous material of the present invention and determining whether at least 50% (core) or less (yolk) of the surface of a given nanostructure (preferably a nanoparticle) contacts the porous shell.

“Nanostructure” refers to an object or material in which at least one dimension of the object or material is equal to or less than 1000 nm (e.g., one dimension is 1 to 1000 nm in size). In a particular aspect, the nanostructure includes at least two dimensions that are equal to or less than 1000 nm (e.g., a first dimension is 1 to 1000 nm in size and a second dimension is 1 to 1000 nm in size). In another aspect, the nanostructure includes three dimensions that are equal to or less than 1000 nm (e.g., a first dimension is 1 to 1000 nm in size, a second dimension is 1 to 1000 nm in size, and a third dimension is 1 to 1000 nm in size). The shape of the nanostructure can be of a wire, a particle (e.g., having a substantially spherical shape), a rod, a tetrapod, a hyper-branched structure, a tube, a cube, or mixtures thereof. “Nanoparticles” include particles having an average diameter size of 1 to 1000 nanometers.

“Microstructure” refers to an object or material in which at least one dimension of the object or material is greater than 1000 nm (e.g., greater than 1000 nm up to 5000 nm) and in which no dimension of the structure is 1000 nm or smaller. The shape of the microstructure can be of a wire, a particle, a sphere, a rod, a tetrapod, a hyper-branched structure, a tube, a cube, or mixtures thereof. “Microparticles” include particles having an average diameter size of greater than 1000 nm, preferably greater than 1000 nm to 5000 nm, or more preferably greater than 1000 nm to 10000 nm.

The phrase “higher metal polysulfides” refers to metal sulfides having a formula of MₓSₙ where 4≤n≤8, M is a metal, and x+n balance the valence requirements of the compound. A non-limiting example of a higher metal polysulfide is Li₂Sₙ where 4≤n≤8 and x is 2.

The phrase “lower polysulfides” refers to metal sulfides having a formula of MₓSₙ where 1≤n≤3, M is a metal, and x+n balance the valence requirements of the compound. A non-limiting example of a lower metal polysulfide is Li₂Sₙ where 1≤n≤3 and x is 2.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %”, “vol. %”, or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having,” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The porous materials of the present invention can “comprise,” “consist essentially of,” or “consist of” particular ingredients, components, compositions, etc. disclosed throughout the specification. With respect to the transitional phase “consisting essentially of,” in one non-limiting aspect, a basic and novel characteristic of the porous materials of the present invention are their abilities to allow the movement of chemical compounds or ions between an external environment and the interior of the material, trap polysulfides and/or absorb metal ions such as lithium ions.

Other objects, features and advantages of the present invention will become apparent from the following figures, detailed description, and/or examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIGS. 1A-1B depict schematics of yolk-shell structures of the present invention.

FIGS. 2A-2E depict schematics of yolk-shell structures of the present invention containing polysulfide trapping agents.

FIG. 3 depicts a schematic of a multi-yolk shell structure that includes polysulfide trapping agents.

FIG. 4 depicts a method of the present invention to produce yolk-shell structures having polysulfide trapping agents in contact with the interior surface of the shell and the yolk.

FIG. 5 depicts another method of the present invention to produce yolk-shell structures having polysulfide trapping agents.

FIG. 6 depicts a method of the present invention to produce yolk-shell structures with polysulfide trapping agents distributed throughout the structures and on the exterior surface of the structures.

FIG. 7 depicts a method of the present invention to produce multi-yolk-shell structures with polysulfide trapping agents distributed throughout the structures.

FIG. 8A is a scanning electron microscopy (SEM) image of TiO₂—ZnS composite nanoparticles.

FIG. 8B is a transmission electron microscopy (TEM) image of TiO₂—ZnS composite nanoparticles.

FIG. 8C is the Energy dispersive X-ray (EDX) data for TiO₂—ZnS composite nanoparticles.

FIG. 8D are the X-ray diffraction (XRD) patterns of ZnS particles, TiO₂ particles, and the TiO₂—ZnS composite.

FIG. 9A is a SEM image of TiO₂—ZnS@PDA core-shell nanoparticles.

FIG. 9B is a TEM image of TiO₂—ZnS@PDA core-shell nanoparticles.

FIG. 9C is the EDX data for TiO₂—ZnS@PDA core-shell nanoparticles

FIG. 9D are the XRD patterns of ZnS particles, TiO₂ particles, the TiO₂—ZnS composite, and TiO₂—ZnS@PDA core-shell nanoparticles.

FIG. 10A is a SEM image of TiO₂—ZnS@C core-shell nanoparticles.

FIG. 10B is a TEM image of TiO₂—ZnS@C core-shell nanoparticles.

FIG. 10C is the EDX data for TiO₂—ZnS@C core-shell nanoparticles

FIG. 10D are the XRD patterns of ZnS particles, TiO₂ particles, and TiO₂—ZnS@C core-shell nanoparticles.

FIGS. 11A and 11B are SEM and TEM images of TiO₂ particles, respectively.

FIG. 11C is a SEM image of TiO₂—S@C core-shell nanoparticles.

FIG. 11D is a TEM image of TiO₂—S@C core-shell nanoparticles.

FIG. 11E are the XRD patterns of TiO₂ particles, sulfur, and TiO₂—S@C core-shell nanoparticles.

FIG. 11F is the thermogravimetric (TGA) scan of the TiO₂—S@C core-shell nanoparticles.

FIG. 12 is a schematic of the preparation of TiO₂—S@C core-shell nanoparticles.

While the invention is susceptible to various modifications and alternative forms, specific embodiments thereof are shown by way of example in the drawings. The drawings may not be to scale.

### DETAILED DESCRIPTION OF THE INVENTION

A discovery has been made that provides a solution to the dissolution of higher metal (e.g., lithiated) polysulfides in a Li—S material (e.g., a Li—S energy device). The solution is premised on a porous material having a sulfur yolk and carbon shell that includes a polysulfide trapping agent. This material provides several advantages over conventional Li—S materials with or without metal oxides. Advantages can include improved cyclability due to the presence of an internal void space inside the carbon shell to accommodate the volume expansion of sulfur during lithiation and/or capture of polysulfides via chemisorption by the polysulfide trapping agent. Furthermore, the yolk-shell structure can be formed into a honeycomb bulk structure to enhance the mechanical strength of the material. Even further advantages are realized when the carbon shell includes a nitrogen species. For example, a nitrogen enriched carbon shell can (1) enhance the electrochemical properties of the porous yolk-shell material, (2) provide high adsorption of sulfur, and (3) provide good mechanical strength.

These and other non-limiting aspects of the present invention are discussed in further detail in the following sections with reference to the figures.

### A. Porous Material Having a Yolk-Shell Structure

The porous material of the present invention can have a yolk-shell structure that includes a polysulfide trapping agent.

1. Yolk/Carbon Shell Structure

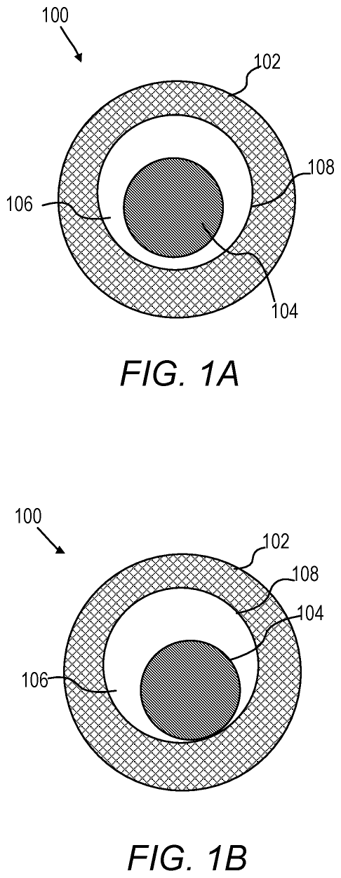

The elemental sulfur yolk/porous carbon-containing shell structure of the present invention includes at least one nanostructure (or in some embodiments a plurality of nanostructures, which can be referred to as a multi-yolk-shell structure) contained within a discrete void space that is present in a carbon shell. FIGS. 1A and 1B are cross-sectional illustrations of porous material 100 having a yolk/porous carbon-containing shell structure. Porous material 100 has porous carbon-containing shell 102, elemental sulfur yolk 104, and void space 106 (hollow space). As discussed in detail below, void space 106 can be formed by oxidation of a sulfur nanostructure precursor material. Wall or interior surface 108 defining void space 106 can be a portion of carbon shell 102. As shown in FIG. 1A, elemental sulfur yolk 104 does not contact shell 102. As shown in FIG. 1B, elemental sulfur yolk 104 contacts a portion of shell 102. In certain aspects, 0% to 49%, 30% to 40%, or at least greater than, equal to, or between any two of 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 36%, 37%, 38%, 39%, 40%, 41%, 42%, 43%, 44%, 45%, 46%, 47%, 48%, or 49% of the surface of elemental sulfur yolk 104 contacts shell 102. In instances where yolk 104 is a particle, the diameter of the yolk 104 can range from 1 nm to 1000 nm, preferably 1 nm to 50 nm, or more preferably 1 nm to 5 nm or at least greater than, equal to, or between any two of 1, 5, 10, 25, 30, 50, 75, 100, 150, 200, 250, 300, 350, 400, 450, 500, 550, 600, 650, 700, 750, 800, 850, 900, 950, and 1000 nm. The porous carbon shell can allow movement of chemical compounds or ions between an external environment and the interior of the material.

2. Yolk/Carbon Shell Structure with Polysulfide Trapping Agent

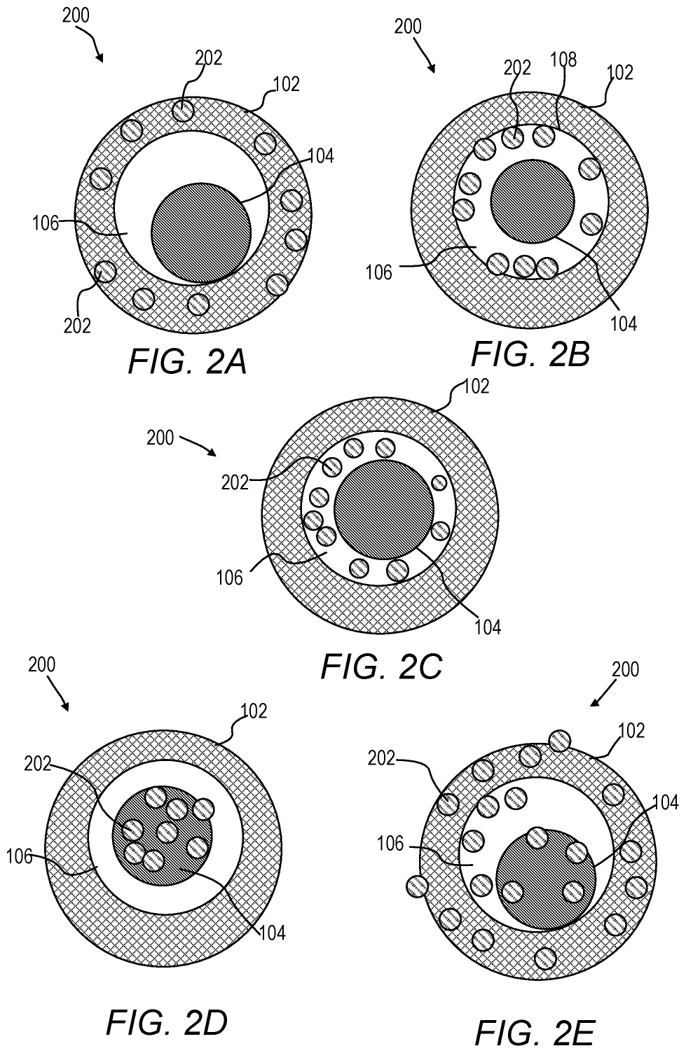

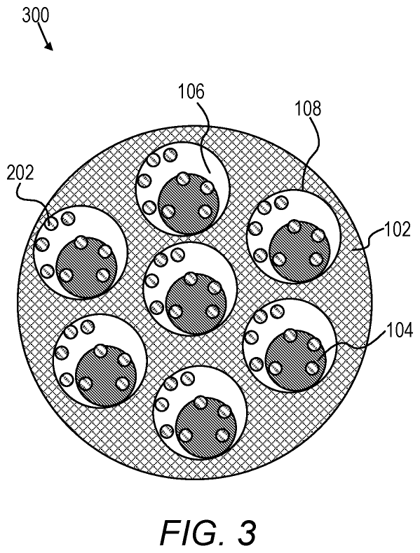

The elemental sulfur/porous carbon containing shell structure can include polysulfide trapping agents. The polysulfide trapping agent, or a plurality of such agents, can be embedded in the carbon-containing porous shell, in contact with the interior surface of the carbon-containing porous shell, comprised in the hollow space, in contact with the elemental sulfur nanostructure, or any combination thereof. The polysulfide trapping agent can be a nanostructure having a high surface area and good surface diffusion properties. Without wishing to be bound by theory, it is believed that the polysulfide trapping agent can bind polysulfides through chemisorption. By way of example, a metal polysulfide (e.g., Li₂Sₙ) can undergo a chemical reaction with the polysulfide trapping agent to bind the metal polysulfide to the surface of the polysulfide trapping agent (chemisorption). This binding can suppress the shuttle effect and enable full utilization of the active material (e.g., lithium ions and elemental sulfur). Therefore reducing the overall volumetric and weight-based energy density of the material, and the overall device. Since the polysulfide trapping agent is distributed in the hollow portion of the shell (e.g., yolk, void or interior surface), or embedded in the carbon surface, the balance between polysulfide adsorption and surface diffusion can be tuned to allow the sulfide species to deposit on the surface of the polysulfide trapping agent. This can enhance the cycling performance of the lithiation process. FIGS. 2A-2E depict the cross-sectional illustrations of porous material 200 with the sulfur yolk and carbon shell structure 100 with polysulfide trapping agents 202. FIG. 2A depicts polysulfide trapping agents 202 embedded in carbon-containing porous shell 102. FIG. 2B depicts polysulfide trapping agents 202 in contact with interior surface 108 of carbon-containing porous shell 102. FIG. 2C depicts polysulfide agents 202 positioned in void space 106. FIG. 2D depicts polysulfide agents 202 in contact with elemental sulfur yolk 104. FIG. 2E depicts polysulfide agents 202 embedded in carbon-containing porous shell 102, in contact with interior surface 108 of the carbon-containing porous shell, comprised in void space 106, and/or in contact with the elemental sulfur nanostructure yolk 104. FIG. 3 depicts honeycomb structure 300 that includes porous carbon-containing shell 102, a plurality of elemental sulfur yolks 104, and a plurality of polysulfide trapping agents in contact with the elemental sulfur yolk, void space 106, and interior surface 108 of the porous carbon-containing shell. In some embodiments, the polysulfide trapping agents are embedded in the porous carbon-containing shell. Compounds suitable for polysulfide trapping agents are discussed in more detail below.

### B. Materials

The materials or material precursors can be obtained from commercial sources, produced as described throughout the specification, or a combination of both.

1. Carbon-Containing Material Precursors

The carbon-containing material can be obtained from an organic precursor compound that has been subjected to condition suitable to convert the organic compound into a porous carbon-containing shell. The organic compound can be an organic polymer, a nitrogen containing organic polymer, or a blend of thereof. Non-limiting examples of organic compounds include polyacrylonitrile (PAN), polydopamine (PDA), polyalkylene, polystyrene, polyacrylate, poly halide, polyester, polycarbonate, polyimide, phenol formaldehyde resin, epoxy, polyalkylene glycol, polysaccharide, polyethylene, polypropylene, polymethylmethacrylate, polyvinyl chloride, polyethylene terephthalate, polyethylene glycol, polypropylene glycol, starch, glycogen, cellulose, or chitin, or any combination thereof. In a preferred embodiment, polyacrylonitrile is converted to the porous carbon-containing shell.

2. Elemental Sulfur and Elemental Sulfur Precursors

The yolk 104 includes elemental sulfur. Elemental sulfur can include, but is not limited to, all allotropes of sulfur (i.e., Sₙ where n=1 to ∞). Non-limiting examples of sulfur allotropes include S, S₂, S₄, S₆, and S₈, with the most common allotrope being S₈. The elemental sulfur precursor can be any material capable of being converted to elemental sulfur. In a preferred embodiment, the elemental sulfur precursor can be a metal sulfide. The metal of the metal sulfide can be a transition metal of the Periodic Table. Non-limiting examples of transition metals include iron (Fe), silver (Ag), copper (Cu), nickel (Ni), zinc (Zn), manganese (Mn), cobalt (Co), lead (Pb), or cadmium (Sn). Non-limiting examples of metal sulfides include ZnS, CuS, MnS, FeS, CoS, NiS, PbS, Ag₂S, or CdS, or any combination thereof. In a preferred embodiment, ZnS is used as the elemental sulfur precursor material. In some embodiments, the metal sulfide (e.g., ZnS) can be prepared from a metal precursor material (e.g., zinc acetate) and a sulfur source (thiourea). The metal precursor material and the sulfur source (e.g., thiourea) can be dissolved in a solvent (e.g., water) and a templating agent (e.g., a surfactant such as gum Arabic) under agitation sufficient to dissolve all the reagents (e.g., sonification). A molar ratio of the metal precursor material to the sulfur source can range from 0.4:1 to 1:1, 0.5:1, 0.6:1, 0.7:1, 0.8:1, 0.9:1, or about 0.5:1. The resulting solution can be heated under hydrothermal conditions (e.g., autogenous) at 110° C. to 140° C., or 115° C. to 130° C., or 120 OC to 125° C., or about 120° C. for at time sufficient to react the metal precursor with the sulfur source to produce metal sulfide nanoparticles (e.g., 10 to 20, or about 15 hours). The resulting metal sulfide nanoparticles can be isolated using known isolation methods (e.g., centrifugation, filtration, and the like), washed with solvent to remove any unreacted reagents, and dried under vacuum (e.g., 60° C. to 80° C. or about 70° C. for about 1 to 5, or about 3 hours). In some embodiments, the polysulfide trapping agent precursor material, polysulfide trapping agent, or mixture thereof can be added to the solution of metal source and sulfur source to form a metal sulfide material having polysulfide trapping agent and/or polysulfide trapping agent precursor material dispersed throughout after heating under autogenous pressure.

3. Polysulfide Trapping Agents and Polysulfide Trapping Agent Precursor Materials

The polysulfide trapping agents can be metal oxides. The metal portion of the metal oxide can be an alkali metal (Column 1 of the Periodic Table), alkaline earth metal (Column 2 of the Periodic Table), a transition metal (Columns 3-12 of the Periodic Table), a post transition metal (metal of Columns 13-15 of the Periodic Table), or a lanthanide metal. Non-limiting examples of metals include magnesium (Mg), aluminum (Al), cerium (Ce), and lanthanum (La), tin (Sn), titanium (Ti), Mn, calcium (Ca), or any combination thereof. Non-limiting examples of metal oxides suitable for use in the present invention include MgO, Al₂O₃, CeO₂, La₂O₃, SnO₂, Ti₄O₇, TiO₂, MnO₂, or CaO, or any combination thereof. In a preferred embodiment, Al₂O₃ and/or TiO₂ is used. The metal oxide can be obtained from metal oxide precursor compounds. For example, the precursor material can be obtained as a metal hydroxide, a metal nitrate, a metal amine, a metal chloride, a metal coordination complex, a metal sulfate, a metal phosphate hydrate, metal complex, or any combination thereof. In some embodiments, the polysulfide trapping agent can be prepared by dissolving a polysulfide trapping agent precursor (e.g., Al(NO₃)₃.9H₂O) in a solvent (e.g., water) and adding a basic precipitation agent (e.g., ethylenediamine) to adjust the pH to 7 to 9, or about 8 to precipitate polysulfide trapping agent precursor (e.g., Al(OH)₃) from the solution. The polysulfide trapping agent precursor can be dried under vacuum, and then calcined at 850 to 1000° C., or about 850° C., 900° C., 950° C., or 1000 OC to convert the polysulfide trapping agent precursor material to a polysulfide trapping agent (e.g., Al(OH)₃ to Al₂O₃).

### C. Preparation of the Porous Material of the Present Invention

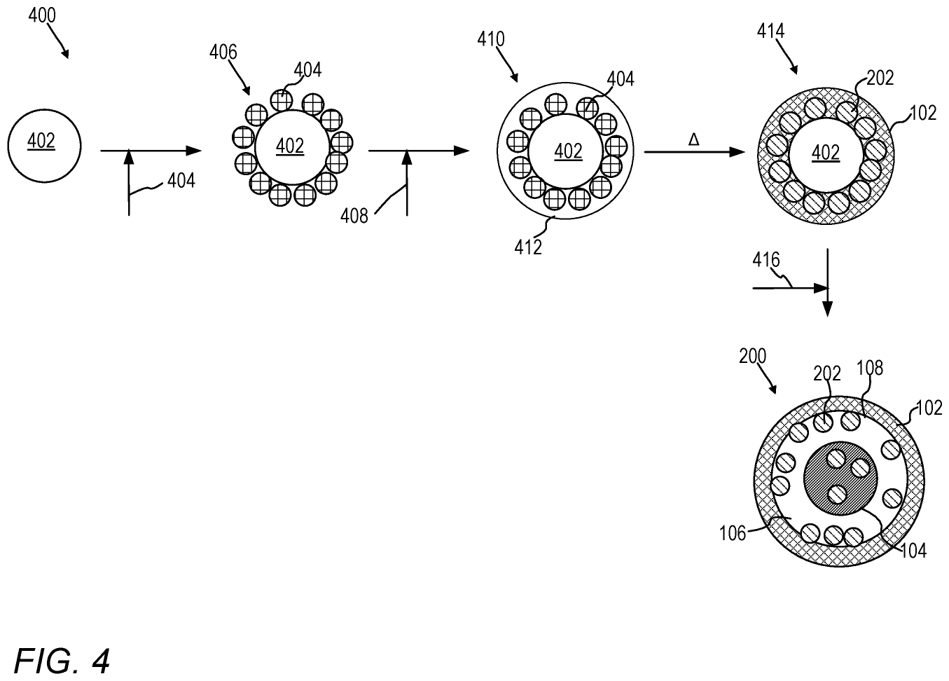

The porous material of the present invention can be made using methods described herein and methods exemplified in the Examples section. FIG. 4 depicts a method to produce a porous material of the present invention having an elemental sulfur yolk, a porous carbon containing shell, and one or more polysulfide trapping agents in contact with the elemental sulfur yolk and the interior surface of the shell. In method 400, elemental sulfur precursor material 402 (e.g., ZnS) can be obtained as described in the Materials Section and coated with a polysulfide trapping agent precursor material 404 (e.g., Al(OH)₃) to form coated polysulfide trapping agent 406. In some embodiments, elemental sulfur precursor material 402 is coated with polysulfide trapping agent nanoparticles (e.g., TiO₂) or a mixture of polysulfide trapping agent nanoparticles and polysulfide trapping agent precursor material. Coated elemental sulfur precursor material 406 can refer to all three types of coatings (i.e., polysulfide trapping agent precursor, polysulfide trapping agent, or a mixture thereof).

Coated elemental sulfur precursor material 406 can be contacted with an organic polymer 408 to form core/shell structure 410 having a coated elemental sulfur precursor core 406 and an organic polymer shell 412. Core/shell structure 410 can be subjected to conditions sufficient to carbonize the organic polymer to form a porous carbon shell 102, and, if necessary, convert the polysulfide trapping agent precursor material 404 to the polysulfide trapping agent 202 (e.g., Al(OH)₃) to Al₂O₃). This forms core/shell structure 414 where the porous carbon shell 102 encompasses the elemental sulfur precursor material core 402 coated with polysulfide trapping agent 202. For example, the core/shell structure 410 can be thermally (heat) treated to 500° C. to 1100° C., 1050° C., 1000° C., 900° C., 800° C., 700° C., or 600° C., or any range or value there between to form core/shell structure 414. The thermal treatment can be done under an inert gas atmosphere, such as nitrogen, argon or helium. The inert gas flow can be from 50 mL/min to 1000 mL/min, 800 mL/min, 600 mL/min, 500 mL/min, 300 mL/min or 100 mL/min or any value or range there between. The pressure during heat treatment can be 0.101 MPa (atmospheric) or higher, for example 10 MPa.

Core/shell structure 414 can be contacted with iron (III) solution (e.g., ferric nitrate) solution 416 to convert elemental sulfur precursor material 402 to elemental sulfur yolk 104, thereby forming yolk/shell structure 200 having porous carbon-containing shell 102, elemental sulfur yolk 104, and polysulfide trapping agents 202. Reduction of the metal sulfide to elemental sulfide produces a smaller compound thereby forming void space 106 in the carbon-containing core. By way of example, core/shell nanostructure 414 can be reduced in size (e.g., ground into fine powder) and mixed with an aqueous ferric nitrate solution. The resulting suspension can be agitated with cooling for a time sufficient to allow the iron to react with the zinc sulfide as follows:

2Fe³⁺_{(aq)}+ZnS₍ₛ₎→2Fe²⁺_{(aq)}+Z²⁺_{(aq)}+S₍ₛ₎.

The resulting yolk/shell structures 200 can be recovered using known methods (e.g., centrifugation, filtration and the like). Mineral acid (e.g., hydrochloric acid) can be added to the yolk/shell structure to remove any remaining zinc sulfide. The particles can be removed via centrifugation, washed several times in deionized water, and then dried at a temperature suitable (e.g., 60° C. to 80° C. or about 70° C.) to remove volatiles until dry (about 2 to 10 hours, or 3 to 5 hours). The isolated yolk/shell structures include elemental sulfur yolk 104 and polysulfide trapping agents 202, both of which are comprised in void space 106 of porous carbon-containing shell 102. Polysulfide trapping agents 202 can also be attached to the surface of elemental sulfur yolk 104. The attachment can be through covalent bonding or ionic bonding (e.g., van der Waals attraction or hydrogen bonding), or adsorption.

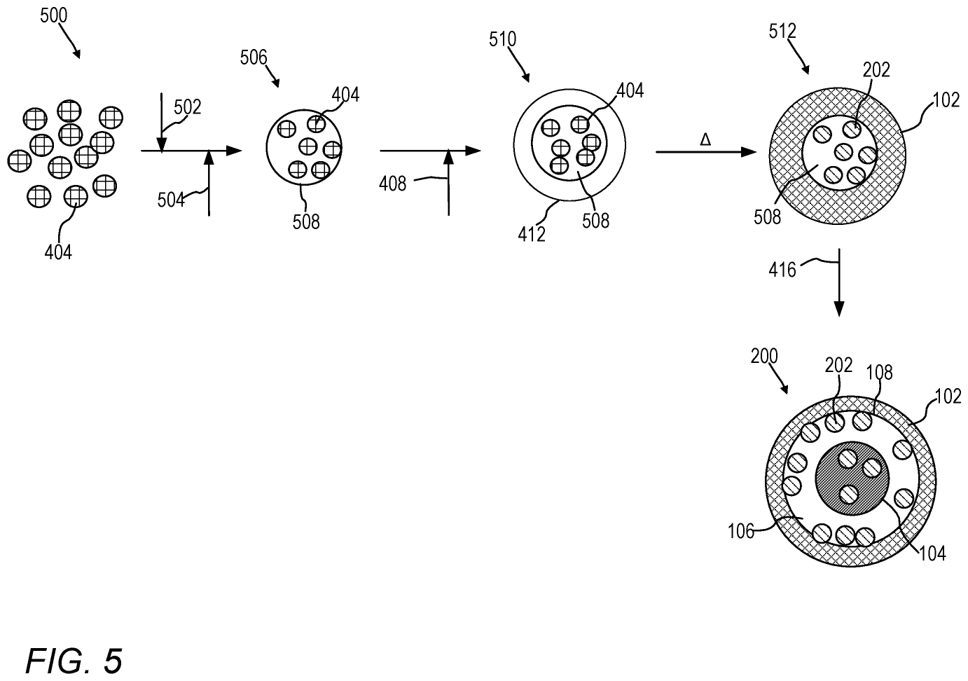

FIG. 5 depicts another method to make yolk/shell structure 200. In method 500, polysulfide trapping agent precursor material 404 or polysulfide trapping agent (e.g., TiO₂ not shown) can be combined with metal source (e.g., zinc acetate) 502 and sulfur source 504 (e.g., thiourea), and then subjected to hydrothermal conditions (e.g., heated under autogenous pressure) to produce elemental sulfur precursor/polysulfide trapping agent precursor material 506 having polysulfide trapping agents 404 dispersed throughout and on the surface of the elemental sulfur precursor material 508. The polysulfide trapping agent precursor material can include nanostructures of polysulfide trapping agent material. In embodiments when polysulfide trapping agents or a mixture of polysulfide trapping agents and/or precursor material are used, an elemental sulfur precursor/polysulfide trapping agent material having polysulfide trapping agents and/or a mixture of polysulfide trapping agents/precursor material dispersed on the surface and/or throughout the elemental sulfur precursor material is produced. In some embodiments, Al(OH)₃ nanoparticles (polysulfide trapping agent precursor), Al₂O₃ or TiO₂ nanostructures (polysulfide trapping agents), or a mixture thereof is used.

Elemental sulfur precursor/polysulfide trapping agent precursor material 506 can be contacted with organic polymer 408 to form core/shell structure 510 having elemental sulfur precursor/polysulfide trapping agent precursor material 506 core and organic polymer shell 412. Core/shell structure 510 can be subjected to conditions sufficient to carbonize organic polymer 412 to form porous carbon shell 102, and, if necessary, convert polysulfide trapping agent precursor material 404 to polysulfide trapping agent 202 (e.g., Al(OH)₃) to Al₂O₃). This forms core/shell structure 512 where the porous carbon shell 102 encompasses elemental sulfur precursor material core 508 with polysulfide trapping agent 202 dispersed throughout. For example, the core/shell structure 510 can be heat-treated to 500° C. to 1100° C., 1050° C., 1000° C., 900° C., 800° C., 700° C., or 600° C. or any range or value there between to form core/shell structure 514. The heat treatment can be done under an inert gas atmosphere, such as nitrogen, argon or helium. The inert gas flow can be from 50 mL/min to 1000 mL/min, 800 mL/min, 600 mL/min, 500 mL/min, 300 mL/min or 100 mL/min or any value or range there between. The pressure during heat treatment can be 0.101 MPa (atmospheric) or higher, for example 10 MPa.

Core/shell structure 512 can be contacted with iron (III) solution (e.g., ferric nitrate) solution 416 as previously described for FIG. 4 and in the Examples. Such treatment can convert elemental sulfur precursor material 508 to elemental sulfur yolk 104, thereby forming yolk/shell structure 200 having porous carbon-containing shell 102, elemental sulfur yolk 104, and polysulfide trapping agents 202. Elemental sulfur yolk 104 and polysulfide trapping agents 202 are comprised in void space 106 of porous carbon-containing shell 102. Polysulfide trapping agents 202 are also dispersed in elemental sulfur yolk 104.

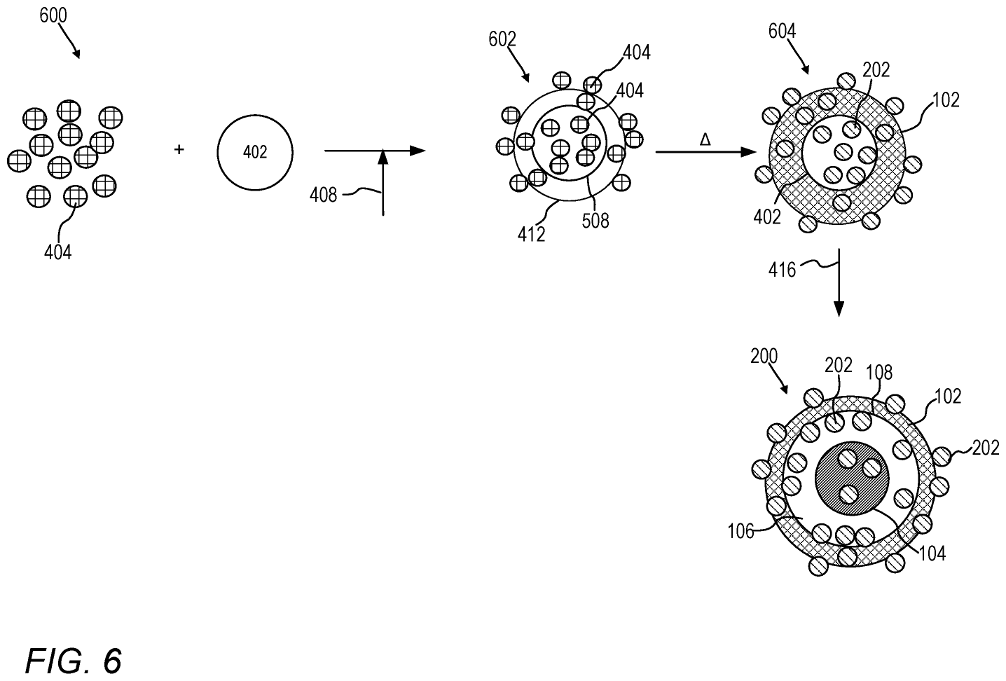

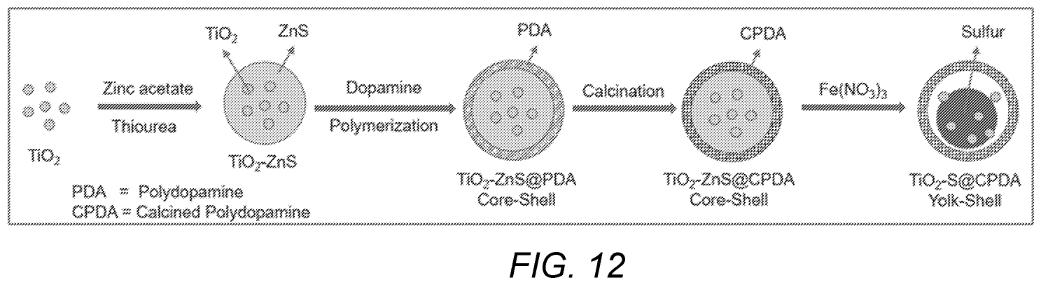

FIG. 6 depicts third method 600 to produce yolk/shell structures 200. A dispersion of elemental sulfur precursor material 402 and polysulfide trapping agent precursor material 404 can be contacted with organic polymer 408 to form core/shell structure 602 having elemental sulfur precursor material core 402, organic polymer shell 412, and polysulfide trapping agent precursor materials 404 dispersed throughout the core and shell materials and on the outer surface of the shell material. In some embodiments, the polysulfide trapping agent precursor materials 404 are not on the outer surface of the shell. The polysulfide trapping agent precursor material can include nanostructures of polysulfide trapping agent material. In embodiments when polysulfide trapping agents (e.g., See FIG. 12 for TiO₂) or a mixture of polysulfide trapping agents and/or precursor material are used, a core/shell structure is produced having an elemental sulfur precursor material core, an organic polymer shell, and polysulfide trapping agent material and/or a mixture of polysulfide trapping agents/polysulfide trapping agent precursor material dispersed throughout the core and shell material and, optionally, on the surface of the shell. In some embodiments, Al(OH)₃ nanoparticles (polysulfide trapping agent precursor), Al₂O₃ nanostructures (polysulfide trapping agents), or a mixture thereof is used.

Core/shell structure 602 can be subjected to conditions sufficient to carbonize organic polymer 412 to form porous carbon shell 102, and, if necessary, convert polysulfide trapping agent precursor material 404 to polysulfide trapping agent 202 (e.g., Al(OH)₃) to Al₂O₃). This forms core/shell structure 604 where porous carbon shell 102 encompasses elemental sulfur precursor material core 402 with polysulfide trapping agent 202 dispersed throughout the shell and core materials. For example, core/shell structure 602 can be heat-treated to 500° C. to 1100° C., 1050° C., 1000° C., 900° C., 800° C., 700° C., or 600 OC or any range or value there between to form core/shell structure 604. The heat treatment can be done under an inert gas atmosphere, such as nitrogen, argon or helium. The inert gas flow can be from 50 mL/min to 1000 mL/min, 800 mL/min, 600 mL/min, 500 mL/min, 300 mL/min or 100 mL/min or any value or range there between. The pressure during heat treatment can be 0.101 MPa (atmospheric) or higher, for example 10 MPa. Core/shell structure 604 can be contacted with an iron (III) solution (e.g., ferric nitrate) solution 416 as previously described for FIG. 4 and in the Examples. Such treatment can convert elemental sulfur precursor material 402 to elemental sulfur yolk 104, thereby forming yolk/shell structure 200 having porous carbon-containing shell 102, elemental sulfur yolk 104, and polysulfide trapping agents 202. Elemental sulfur yolk 104 and polysulfide trapping agents 202 are comprised in void space 106 of the porous carbon-containing shell 102. Polysulfide trapping agents 202 are also dispersed in the elemental sulfur yolk 104 and carbon shell. As shown, polysulfide trapping agents are on the outer surface 606 of shell 102. In some embodiments, polysulfide trapping agents are not dispersed the outer surface 606 of the shell 102.

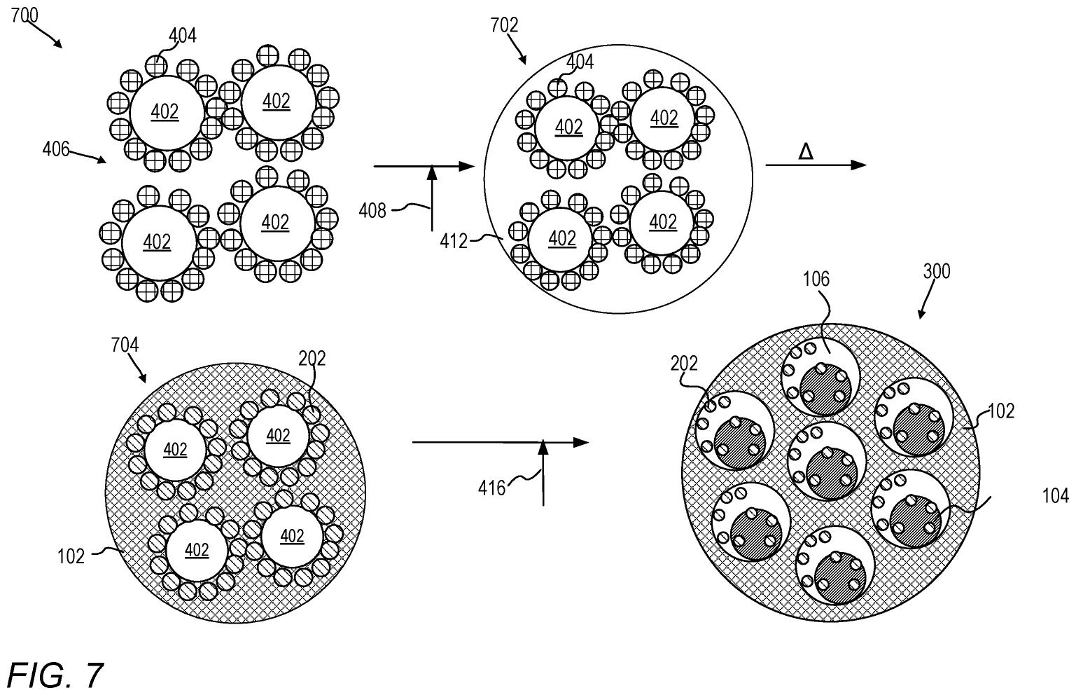

FIG. 7 depicts a method to produce a multi-yolk/shell structure (e.g., a honeycomb structure). In method 700, a plurality of coated core structures 406 (e.g., ZnS coated with Al(OH)₃ nanostructures) can be contacted with organic polymer 408 to form polymer coated multi-core material 710. As described above, polysulfide trapping agents or a mixture of polysulfide trapping agents and polysulfide trapping agent precursor material can be used as a coating material. Multi-core/shell structure 710 can be subjected to conditions sufficient to carbonize organic polymer 412 to form porous carbon shell 102, and, if necessary convert polysulfide trapping agent precursor material 404 to polysulfide trapping agent 202 (e.g., Al(OH)₃) to Al₂O₃). This forms multi-core/shell structure 704 where the porous carbon-containing shell 102 encompasses the elemental sulfur precursor material core 402 with polysulfide trapping agent 202 dispersed throughout the shell and multi-core materials. For example, core/shell structure 704 can be heat-treated to 500° C. to 1100° C., 1050° C., 1000° C., 900° C., 800° C., 700° C., or 600 OC or any range or value there between to form core/shell structure 706. The heat treatment can be done under an inert gas atmosphere, such as nitrogen, argon or helium. The inert gas flow can be from 50 mL/min to 1000 mL/min, 800 mL/min, 600 mL/min, 500 mL/min, 300 mL/min or 100 mL/min or any value or range there between. The pressure during heat treatment can be 0.101 MPa (atmospheric) or higher, for example 10 MPa.

Multi-core/shell structure 706 can be contacted with an iron (III) solution (e.g., ferric nitrate) solution 416 as previously described for FIG. 4 and in the Examples. Such treatment can convert elemental sulfur precursor materials 402 to elemental sulfur yolks 104, thereby forming multi-yolk/shell structure 300 having porous carbon-containing shell 102, elemental sulfur yolks 104, and polysulfide trapping agents 202. Elemental sulfur yolks 104 and polysulfide trapping agents 202 are comprised in void spaces 106 of the porous carbon-containing shell 102.

D. Uses of the Porous Carbon-Containing Material with Yolk-Shell Structure

The porous carbon-containing materials of the present invention can be used in a variety of energy storage applications or devices (e.g., fuel cells, batteries, supercapacitors, electrochemical capacitors, lithium-ion battery cells or any other battery cell, system or pack technology), optical applications, and/or controlled release applications. The term “energy storage device” can refer to any device that is capable of at least temporarily storing energy provided to the device and subsequently delivering the energy to a load. Furthermore, an energy storage device may include one or more devices connected in parallel or series in various configurations to obtain a desired storage capacity, output voltage, and/or output current. Such a combination of one or more devices may include one or more forms of stored energy. By way of example a lithium ion battery can include the previously described porous carbon-containing material or multi-yolk/porous carbon-containing material (e.g., on an anode electrode and/or a cathode electrode). In another example, the energy storage device can also, or alternatively, include other technologies for storing energy, such as devices that store energy through performing chemical reactions (e.g., fuel cells), trapping electrical charge, storing electric fields (e.g., capacitors, variable capacitors, ultracapacitors, and the like), and/or storing kinetic energy (e.g., rotational energy in flywheels). In some embodiments, the article of manufacture is a virtual reality device, an augmented reality device, a fixture that requires flexibility such as an adjustable mounted wireless headset and ear buds, a communication helmet with curvatures, a medical patch, a flexible identification card, a flexible sporting good, a packaging material and applications where the energy source can simply final product design, engineering and mass production.

In some instances, the flexible composites of the present invention can enhance energy density and flexibility of flexible supercapacitors (FSC). The resultant flexible composites can include an open two-dimensional surface of graphene that can contact an electrolyte in the FSC. Moreover, the conjugated π electron (high-density carrier) of graphene can minimize the diffusion distances to the interior surfaces and meet fast charge-discharge of supercapacitors. Further, micropores of the composites of the present invention can strengthen the electric-double-layer capacitance, and mesopores can provide convenient pathways for ions transport.

### EXAMPLES

The present invention will be described in greater detail by way of specific examples. The following examples are offered for illustrative purposes only, and are not intended to limit the invention in any manner. Those of skill in the art will readily recognize a variety of noncritical parameters, which can be changed or modified to yield essentially the same results.

Instrumentation.

SEM images were obtained using a FEI Nova NanoSEM™ (ThermoFisher Scientific, U.S.A.). Energy dispersive X-ray (EDX) was obtained using a the FEI Nova NanoSEM operated at 10-20 kV. X-ray diffraction (XRD) were obtained using a powder PANalytical Empyrean diffractometer (PANalytical, The Netherlands). Thermogravimetric analysis (TGA) was obtained using a TGA Q500 (TA Instruments, U.S.A.) from 25 to 800° C. with a heat ramp of 10° C./min under nitrogen atmosphere.

### Example 1

### Preparation and Characterization of Elemental Sulfur Precursor Material (TiO₂—ZnS) Composite Nanoparticles

Preparation.

The procedure of Ding et al., (Journal of Materials Chemistry A, 2015, 3:1853-1857) was followed to prepare zinc sulfide (ZnS) nanoparticles. Zinc acetate dihydrate (8.78 g, 0.04 mol, Sigma-Aldrich®, U.S.A.), titanium dioxide nanoparticles (TiO₂, 0.04 mol, 3.2 g, particle size of 21 nm, Sigma-Aldrich®, U.S.A.) and thiourea (6.08 g, 0.08 mol, Sigma-Aldrich®, U.S.A.) were dissolved in deionized water (400 mL) and added into a polyfluoroethylene bottle. Gum arabic (6 g, Sigma-Aldrich®, U.S.A.) was added as a surfactant for the formation of the spheres. The solution was stirred and sonicated to ensure complete dissolution of the reagents and then the bottle was positioned in a polyfluoroethylene lined autoclave. The autoclave was sealed and placed into an oven at about 120° C. for 15 hours. The resulting white zinc sulfide precipitate was isolated via centrifugation, washed several times with deionized water, and then dried in an oven at about 70° C. for 3 hours.

Characterization.

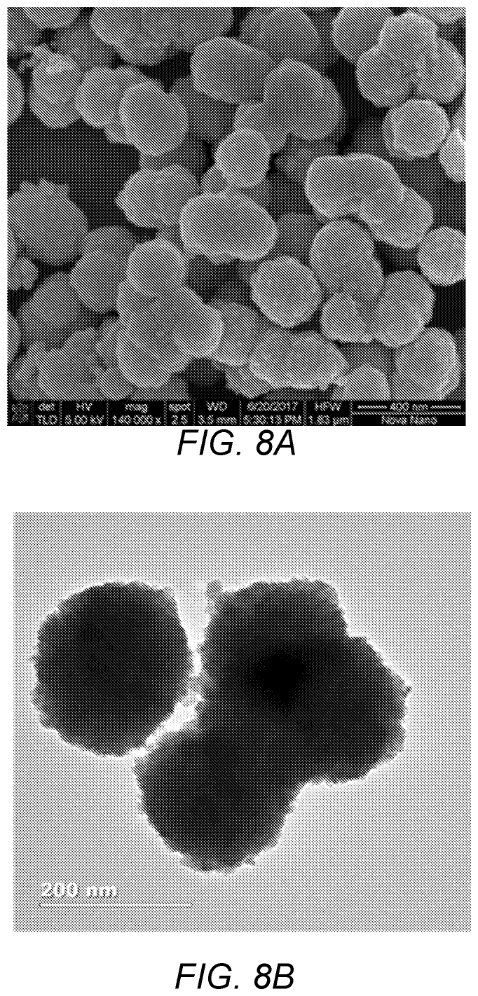

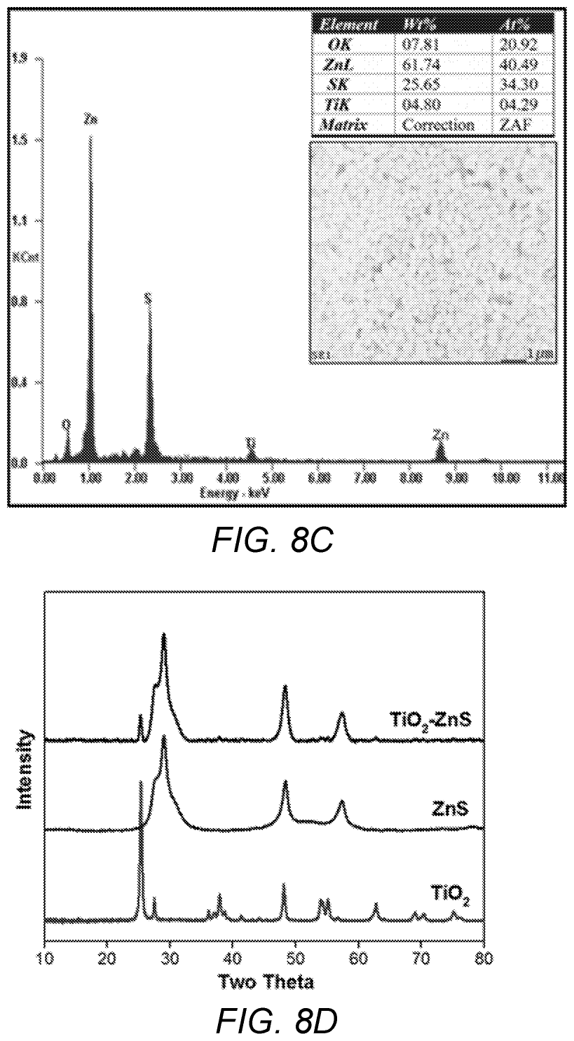

FIGS. 8A and 8B show the SEM and TEM images of TiO₂—ZnS composite nanoparticles. Using these images, the size was determined to be around 220 nm. EDX analysis (FIG. 8C) shows the composite particles contained Zn, S, Ti and O atoms, which indicated the desired composite was obtained. The composite particles included 7.81 wt. % 0, 61.74 wt. % Zn, 25.65 wt. % S, and 4.8 wt. % Ti. The XRD patterns (FIG. 8D) also provided proof that the synthesized particles contained ZnS and TiO₂. As shown in FIG. 8D, the XRD of TiO₂—ZnS contained all the peaks of ZnS and TiO₂.

### Example 2

### Preparation and Characterization of TiO₂—ZnS@PDA Core-Shell Nanoparticles

Preparation

TiO₂—ZnS (2 g) and tris(hydroxymethyl)aminomethane (1.44 g, 12 mmol) of Example 1 were dispersed in H₂O (400 mL) by Soinc Dismembrator (Fisher Scientific (USA), Model 550, 40%, lh) and then dopamine hydrochloride (0.8 g, 4 mmol) was added to the dispersion, and the dispersion was stirred for 3 days at room temperature. The product TiO₂—ZnS@PDA was collected via centrifugation, washed with deionized (DI) water 3 times and ethanol twice, and then dried under vacuum at 70° C. overnight.

Characterization.

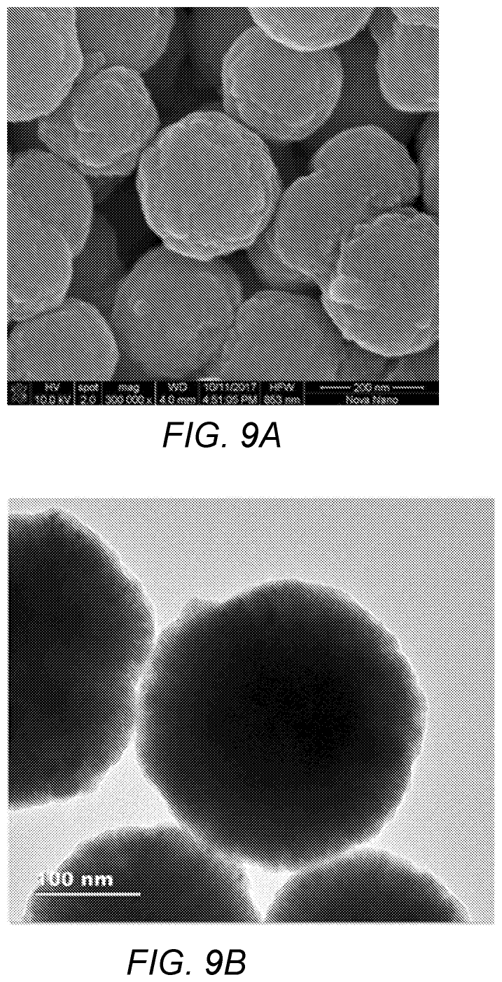

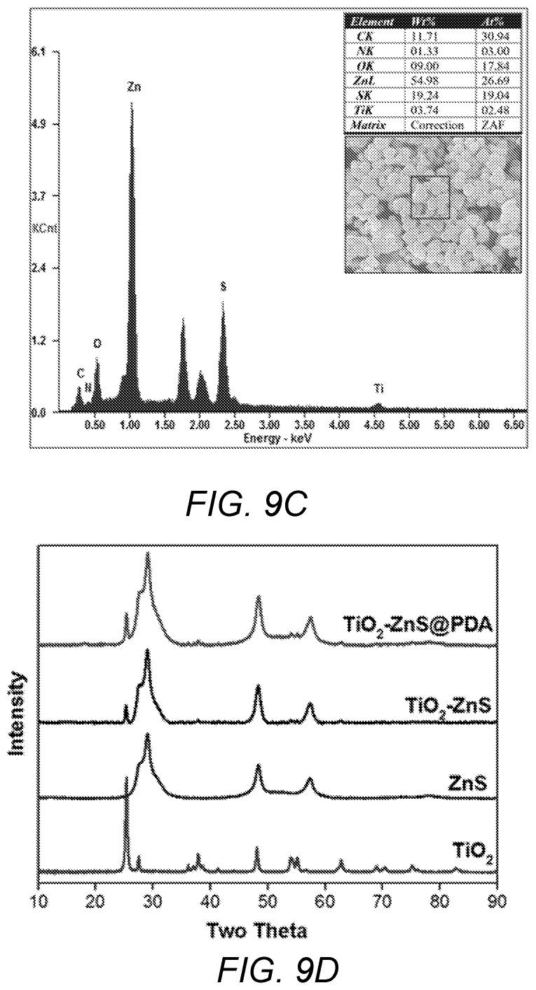

FIGS. 9A and 9B show the SEM and TEM images of TiO₂—ZnS@PDA core-shell particles. The TEM image shows a very thin layer on the surface of TiO₂—ZnS particles. From, the EDX analysis (FIG. 9C) it was determined that the core-shell particles contained C, Zn, S, Ti, N and O atoms. The core-shell particles included 11.71 wt. % C, 1.33 wt. %, N, 7.0 wt. % 0, 54.98 wt. % Zn, 19.24 wt. % S, and 3.74 wt. % Ti. The contained C and N atoms are from polydopamine. The XRD patterns (FIG. 9D) were used to verify that the synthesized particles contained ZnS and TiO₂. The XRD of known samples of Zn and TiO₂ were compared to the XRD of TiO₂—ZnS@PDA. The XRD of TiO₂—ZnS@PDA contained all peaks of ZnS and TiO₂. Thus, the prepared product contained ZnS and TiO₂. PDA did not exhibit a peak due to its amorphous structure.

### Example 3

### Preparation and Characterization of Polysulfide Trapping Agent Material and Elemental Sulfur Precursor Material Cores and Porous Carbon Shells TiO₂—ZnS@C

Preparation of TiO₂—ZnS@C Core-Shell Particles.

TiO₂—ZnS@PDA (0.8 g) from Example 2 was loaded into tubular furnace and heated from room temperature to 900° C. at 5° C./min and kept 10 min under nitrogen gas at 200 cc/min. After cooling down to room temperature, a black powder (0.48 g) was obtained.

Characterization.

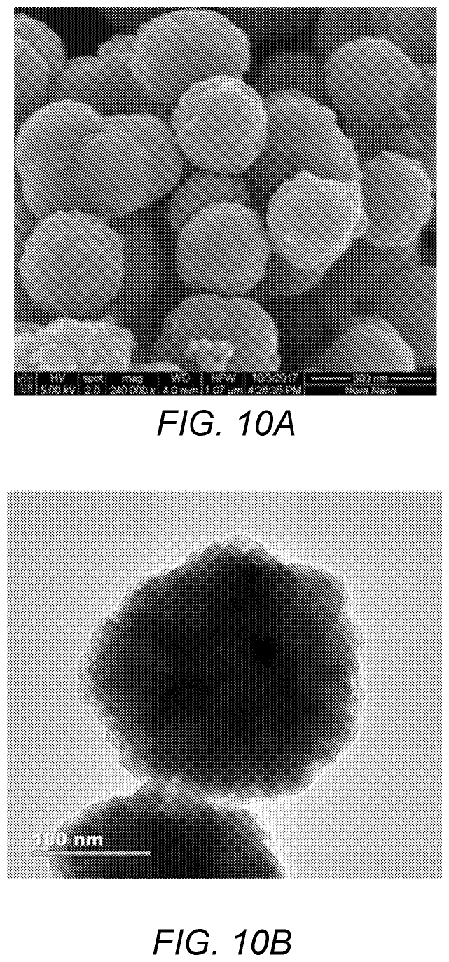

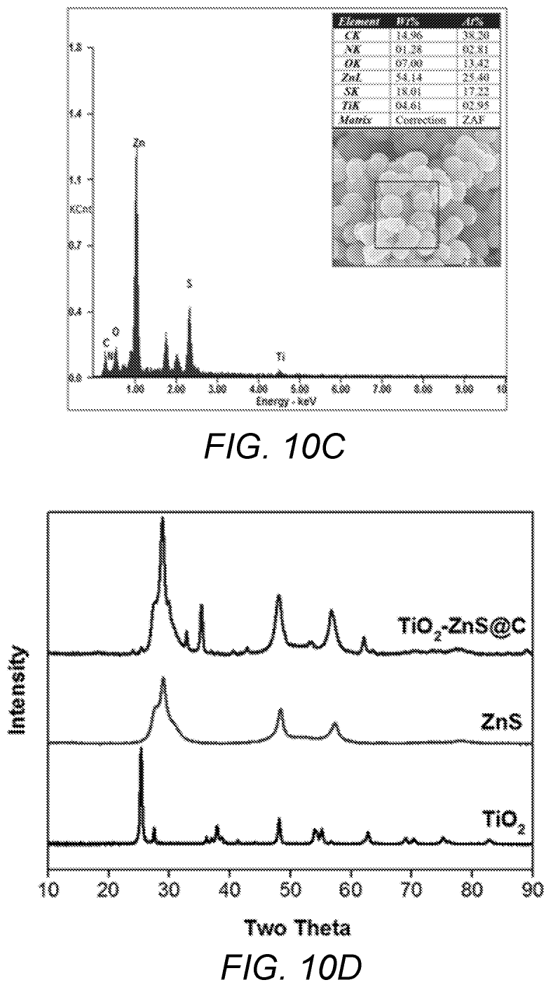

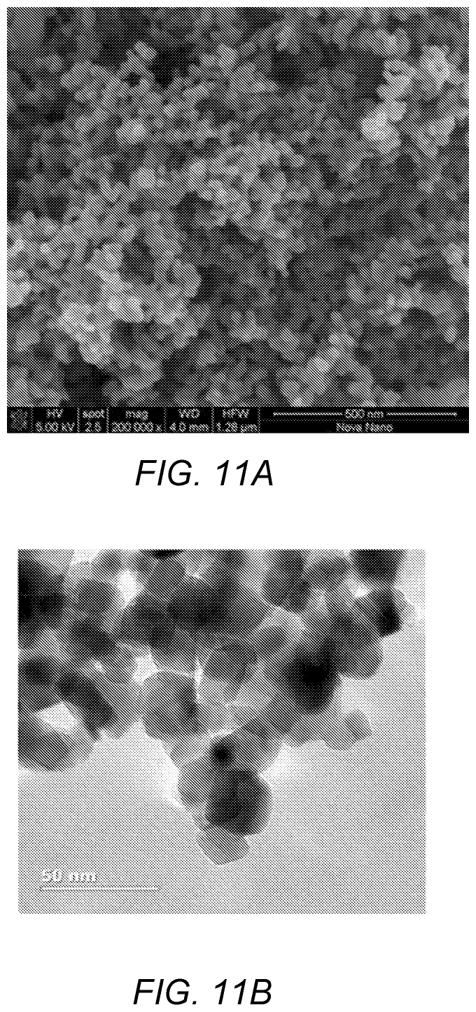

FIGS. 10A and 10B show the SEM and TEM images of TiO₂—ZnS@CPDA core-shell particles. The TEM image shows a very thin layer is on the surface of TiO₂—ZnS particles. From the EDX analysis (FIG. 10C) it was determined that the core-shell particles contained Zn, S, Ti, N and O atoms. The core-shell particles included 14.96 wt. % C, 1.28 wt. %, N, 7.0 wt. % 0, 54.14 wt. % Zn, 18.01 wt. % S, and 4.61 wt. % Ti. The contained N atoms were from carbonized polydopamine. The XRD (FIG. 10D) of known samples of Zn and TiO₂ were compared to the XRD of TiO₂—ZnS@CPDA and the XRD of TiO₂—ZnS@CPDA contained all peaks of ZnS and TiO₂. Thus, the prepared product contained ZnS and TiO₂. PDA did not exhibit a peak due to its amorphous structure.

### Example 4

### Preparation and Characterization of Polysulfide Trapping Agent Material and Elemental Sulfur Core and Porous Carbon-Containing Shell

Preparation of TiO₂-Containing S@C Yolk-Shell Particles (TiO₂—S@CPDA).

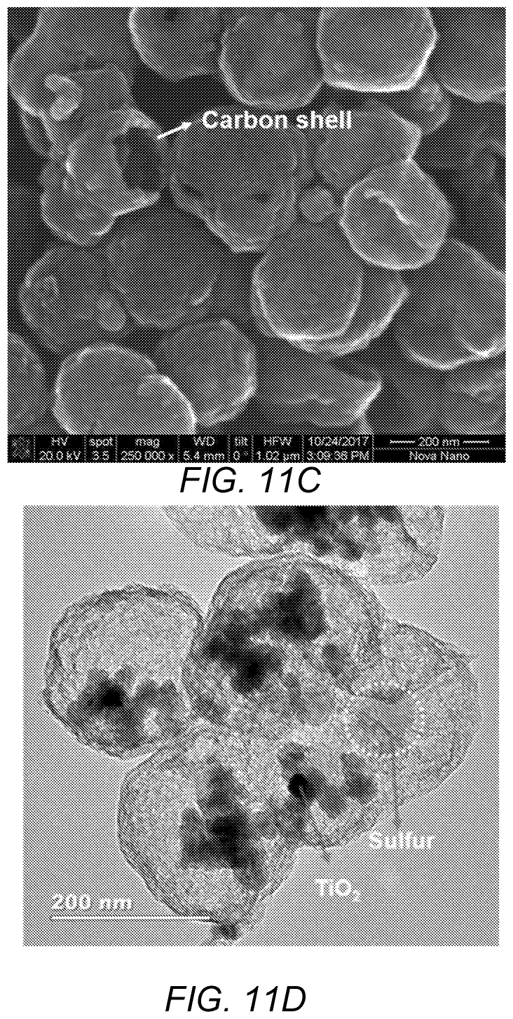

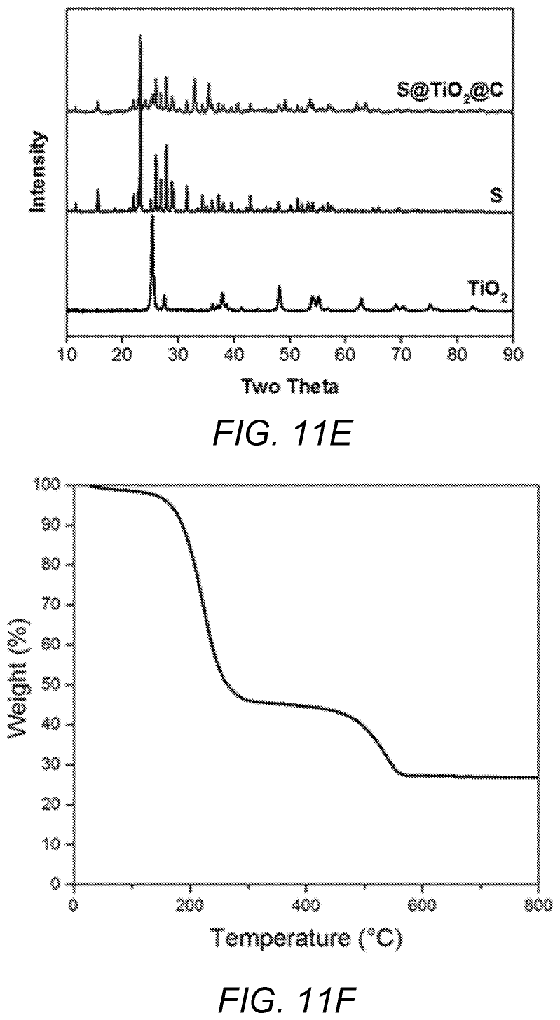

The obtained TiO₂—ZnS@CPDA core-shell particles of Example 3 were mixed with an aqueous ferric nitrate solution (5 mL, 2 M, Sigma-Aldrich®, U.S.A.). The suspension was held in an ice-water bath for 15 hours with stirring, and the resulting particles recovered using centrifugation. Hydrochloric acid was added to remove any remaining zinc sulfide. The resulting TiO₂-containing S@C particles were isolated via centrifugation, washed several times in deionized water, and then dried in an oven at 60° C. for 3 hours under vacuum. Characterization. FIGS. 11A and 11B show the SEM and TEM images of TiO₂ nanoparticles which purchased from Sigma-Aldrich®, U.S.A. The particle size was determined to be around 21 nm. FIGS. 11C and 11D show the SEM and TEM images of TiO₂—S@CPDA yolk-shell particles. ZnS was oxidized to sulfur using a Fe(NO₃)₃ solution. The broken particle in FIG. 11C clearly shows a hollow shell is formed. The TEM image (FIG. 11D) shows TiO₂ nanoparticles and sulfur are encapsulated by a carbon shell. The XRD pattern of TiO₂—S@CPDA yolk-shell particles (FIG. 11E) demonstrated that sulfur was formed when compare with the XRD pattern of sulfur. The weight ratio of sulfur was around 55% as determined by TGA (FIG. 11F).

FIG. 12 is a schematic of the process of Examples 5-8.

### Example 5 (Prophetic)

### (Preparation of Elemental Sulfur Precursor Material (ZnS) Nanoparticles)

The procedure of Ding et al., (Journal of Materials Chemistry A, 2015, 3:1853-1857) will be followed to prepare zinc sulfide (ZnS) nanoparticles. Zinc acetate dehydrate (0.04 mol, Sigma-Aldrich®, U.S.A.) and thiourea (0.08 mol, Sigma-Aldrich®, U.S.A.) will be dissolved in deionized water (400 mL) and added into a polyfluoroethylene bottle. Gum arabic (6 g, Sigma-Aldrich®, U.S.A.) will be added as a surfactant for the formation of the spheres. The solution will be stirred and sonicated to ensure complete dissolution of the reagents and then the bottle will be positioned in a polyfluoroethylene lined autoclave. The autoclave will be sealed and placed into an oven at about 120° C. for 15 hours. The resulting white zinc sulfide precipitate will be isolated via centrifugation, washed several times with demonized water, and then dried in an oven at about 70° C. for 3 hours.

### Example 6 (Prophetic)

### Preparation of Polysulfide Trapping Agent Precursor Material (Al(OH)₃) Nanoparticles

The procedure of Goudarzi et al., (Journal of Cluster Science, 2015, 27:25-38) will be followed to prepare Al(OH)₃ and Al₂O₃ nanoparticles. Al(NO₃)₃.9H₂O (3 g, Sigma-Aldrich®, U.S.A.) will be dissolved in 100 mL of distilled water. Ethylenediamine as a precipitation agent will be added until the pH of the solution was adjusted to 8. The precipitate of Al(OH)₃ will be centrifuged, rinsed with distilled water, dried in an oven at about 60° C. For preparation of alumina (Al₂O₃), the Al(OH)₃ product will be calcined at 900° C. for 2 h.

### Example 7 (Prophetic

### Preparation of Polysulfide Trapping Agent Material and Elemental Sulfur Precursor Material Cores and Porous Carbon Shells

Preparation of Al₂O₃/ZnS@C core-shell particles. Polyacrylonitrile (0.1 g, PAN, Sigma-Aldrich®, U.S.A.) will be dissolved in N,N-Dimethylformamide (1 mL, DMF, Sigma-Aldrich@, U.S.A.) and then mixed with Al₂O₃ (0.05 g, Example 6) and ZnS (0.9 g, Example 5) nanoparticles using ultrasonic mixing. The resulting mixture will be dried under vacuum at 60° C. The dried Al₂O₃/ZnS core and PAN shell particles will be loaded into a tubular furnace and heated at 800° C. under argon for 2 hours to produce a porous material of the present invention having an alumina-containing porous carbon-containing shell and an alumina-containing ZnS core.

### Example 8 (Prophetic)

### Preparation of Polysulfide Trapping Agent Material and Elemental Sulfur Core and Porous Carbon-Containing Shell

Preparation of Al₂O₃-containing S@C yolk-shell particles. The obtained Al₂O₃/ZnS@C core-shell particles of Example 7 will be ground into fine powder, and mixed with an aqueous ferric nitrate solution (20 mL, 2 M, Sigma-Aldrich@, U.S.A.). The suspension will be held in an ice-water bath for 15 hours with stirring, and the resulting particles recovered using centrifugation. Hydrochloric acid will be added to each sample to remove any remaining zinc sulfide. The resulting Al₂O₃-containing S@C particles will be isolated via centrifugation, washed several times in deionized water, and then dried in an oven at 70° C. for 3 hours.

1. A porous material having a yolk-shell structure, the porous material comprising:
(a) an elemental sulfur nanostructure;
(b) a carbon-containing porous shell with an exterior surface and an interior surface that defines and encloses a hollow space within the interior of the shell, wherein the elemental sulfur nanostructure is comprised in the hollow space; and
(c) a polysulfide trapping agent.

2. The porous material of claim 1, wherein the polysulfide trapping agent is embedded in the carbon-containing porous shell, in contact with the interior surface of the carbon-containing porous shell, comprised in the hollow space, and/or in contact with the elemental sulfur nanostructure, or any combination thereof.

3. The porous material of claim 2, wherein the polysulfide trapping agent is comprised in the hollow space and/or in contact with the elemental sulfur nanostructure.

4. The porous material of claim 1, wherein the polysulfide trapping agent is a metal oxide.

5. The porous material of claim 4, wherein the metal oxide comprises at least one member selected from the group consisting of MgO, Al₂O₃, CeO₂, La₂O₃, SnO₂, Ti₄O₇, TiO₂, MnO₂, and CaO, or any mixture or blend thereof.

6. The porous material of claim 5, wherein the metal oxide is selected from the group consisting of Al₂O₃, TiO₂ or a mixture thereof.

7. The porous material of claim 1, wherein the elemental sulfur nanostructure is derived from a metal sulfide.

8. The porous material of claim 7, wherein the metal sulfide comprises a transition metal selected from the group consisting of zinc (Zn), copper (Cu), cobalt (Co), manganese (Mn), iron (Fe), nickel (Ni), lead (Pb), silver (Ag) and cadmium (Cd), or any mixture of blend thereof.

9. The porous material of claim 8, further comprising a honeycomb structure such that the material includes a plurality of hollow spaces within the interior of the shell and a plurality of the elemental sulfur nanostructures, wherein each of the hollow spaces includes the elemental sulfur nanostructure comprised in the hollow space.

10. The porous material of claim 9, wherein the material is comprised in an electrode, a cathode, of an energy storage device, or a lithium-sulfur secondary battery.

11. A method of making the porous material of claim 1, the method comprising:
(a) obtaining a core-shell material comprising an elemental sulfur precursor material core, a carbon-containing shell encompassing the core, and a polysulfide trapping agent and/or a polysulfide trapping agent precursor material;
(b) heat-treating the core-shell material to (i) form a carbon-containing porous shell and optionally (ii) oxidize the polysulfide trapping agent precursor material to form a polysulfide trapping agent; and
(c) subjecting the core-porous shell material to conditions sufficient to oxidize the elemental sulfur precursor material core to form an elemental sulfur nanostructure comprised within a hollow space of the porous shell.

12. The method of claim 11, wherein the core-shell material in step (a) is obtained by:
(i) coating the elemental sulfur precursor material core with a polysulfide trapping agent and/or a polysulfide trapping agent precursor material; and
(ii) forming a carbon-containing shell around the coated elemental sulfur precursor material core.

13. The method of claim 12, wherein a plurality of elemental sulfur precursor material cores are coated with the polysulfide trapping agent and/or polysulfide trapping agent precursor material, and wherein the carbon-containing shell encompasses the plurality of the coated elemental sulfur precursor material cores.

14. The method of claim 11, wherein the core-shell material in step (a) is obtained by:
(i) obtaining a dispersion comprising the polysulfide trapping agent and/or polysulfide trapping agent precursor material dispersed with a sulfur source and a metal source; and
(ii) forming a carbon-containing shell around the dispersion.

15. The method of claim 11, wherein the core-shell material in step (a) is obtained by:
(i) obtaining a mixture comprising the polysulfide trapping agent and/or polysulfide trapping agent precursor material, the elemental precursor material core, and a carbon-containing shell forming material; and
(ii) forming a carbon-containing shell around the polysulfide trapping agent precursor material and the elemental precursor material core.

16. The method of claim 11, wherein less than 50% of the surface of the elemental sulfur nanostructure contacts an interior surface of the porous shell.

17. The method of claim 11, wherein the carbon-containing shell encompassing the core in step (a) comprises an organic polymer.

18. The method of claim 17, wherein the organic polymer is selected from the group consisting of polyacrylonitrile, polydopamine, polyalkylene, polystyrene, polyacrylate, poly halide, polyester, polycarbonate, polyimide, phenol formaldehyde resin, epoxy, polyalkylene glycol, polysaccharide, polyethylene, polypropylene, polymethylmethacrylate, polyvinyl chloride, polyethylene terephthalate, polyethylene glycol, polypropylene glycol, starch, glycogen, cellulose and chitin, or any combination thereof.

19. The method of claim 11, wherein the elemental sulfur precursor material comprises a metal sulfide selected from the group consisting of ZnS, CuS, MnS, FeS, CoS, NiS, PbS, Ag₂S and CdS, or any combination thereof.

20. An energy storage device comprising the porous material of claim 1, wherein the porous material is comprised in an electrode of the energy storage device.
